(19) United States
(12) Patent Application Publication
(10) Pub. No.: US 2015/0153242 A1
(43) Pub. Date: Jun. 4, 2015

(54) Method for monitoring a pressure sensor of a fuel injection system, especially of a motor vehicle

(71) Applicant: Robert Bosch GmbH, Stuttgart, DE (US)

(72) Inventors: Achim JENNE, Oberaichen (Leinfelden/Echterd) (DE); Tobias HILLENBRAND, Ludwigsburg (DE)

(21) Appl. No.: 14/524,609

(22) Filed: Oct. 27, 2014

(30) Foreign Application Priority Data
Nov. 29, 2013 (DE) 10 2013 221 978.4

(51) Int. Cl. G01L 27/00; F02D 41/22

(52) U.S. Cl. CPC G01L 27/007; F02D 41/222; F02D 2041/223

(57) ABSTRACT

A method for monitoring a pressure sensor of a fuel metering system of an internal combustion engine, the metering system having a metering unit controlling the inflow of fuel into a rail; fuel being metered from the rail into combustion chambers of the engine; a pressure regulating valve being connected to the rail, using which the outflow of fuel from the rail into a low-pressure accumulator being regulated; and using the pressure sensor, the pressure is measured in the rail; and for a closed pressure regulating valve, the supplying of current to the pressure regulating valve is lowered until the regulating valve opens and effects a pressure drop in the rail and at least one pressure value recorded by the pressure sensor is compared to the pressure drop in the rail, and from the comparison result, a conclusion is drawn on the functional capability of the pressure sensor.

### RELATED APPLICATION INFORMATION

The present application claims priority to and the benefit of German patent application no. 10 2013 221 978.4, which was filed in Germany on Oct. 29, 2013, the disclosure of which is incorporated herein by reference.

### FIELD OF THE INVENTION

The present invention relates to a method for monitoring a pressure sensor of a fuel metering system of an internal combustion engine, particularly of a motor vehicle. Furthermore, the present invention relates to a computer program which carries out all the steps of the method according to the present invention, when it is running on an arithmetic unit or a control device, as well as a computer program product having program code, which is stored on a machine-readable carrier, for carrying out the method according to the present invention, when the program is run on an arithmetic unit or a control device.

### BACKGROUND INFORMATION

German document DE 10 2004 049 812 A1 discusses a fuel metering system, to which the present document also relates, in particular, a fuel injection system of a common rail (CR) system, as well as a method for its operation. The fuel injection system has a high pressure pump, to which fuel is supplied via a metering unit, and which pumps the fuel supplied with high pressure into a fuel accumulator (that is, presently, the so-called “rail”). Using injection valves or injectors, fuel from the rail is injected into combustion chambers of the internal combustion engine. The metering unit situated before the high pressure pump regulates the fuel supply to the high pressure pump and thus to the rail. In addition, a pressure regulating valve is situated on the rail, which controls the fuel outflow from the rail that is under high pressure into a low pressure system. Furthermore, a pressure sensor, i.e. a rail pressure sensor in this case, is assigned to the rail, with which the fuel pressure (“rail pressure”) is measured in the rail.

In a CR system, a rail pressure sensor mentioned is used both for regulating the rail pressure and for determining the fuel quantity to be injected into the respective injector. As is known, the evaluation of the sensor signal takes place using a rail pressure sensor characteristic curve, in which values of the rail pressure are plotted against the electric voltage. A malfunction of the rail pressure sensor and a drift behavior in the operation and over the service life of the rail pressure sensor work out negatively on the accuracy of the rail pressure to be set, and accordingly also disadvantageously on the accuracy of the injected fuel quantity.

Based on the direct influence on the injection quantity, a rail pressure sensor is ranked as relevant for an on-board diagnosis (OBD), and therefore has to be monitored accordingly in the operation of a motor vehicle. Thus, in countries like the USA, the provision of such a functional test of a rail pressure sensor is even specified by law.

Two different diagnostic methods are known, from the related art, for a rail pressure sensor, namely an offset test and a so-called APCV function (=adaptive pressure control valve). In the offset test it is checked whether the sensor characteristic curve mentioned has an offset error. In this context, the rail pressure signal is compared in specified operating states with values to be expected, and, as a function of the comparison, a faulty rail pressure signal is detected. However, such an offset test is only able to be carried out in operating states of the internal combustion engine or the CR system, in which the fuel in the rail is completely pressure-reduced, i.e. only when the internal combustion engine is shut down or switched off. This test has the additional disadvantage that a functional test is only able to be carried out in a very restricted operating range of the rail pressure sensor, namely, near the zero point of the rail pressure sensor characteristic curve mentioned, and only at points in time at which the rail pressure has already been dissipated completely, e.g. before the start of the internal combustion engine, or in the coasting down that takes place after shutting down the engine.

The sensor characteristic curve is able to be adapted using the APCV function mentioned. For this purpose, when (quasi) stationary operating conditions and an activated pressure regulating valve are present, the actual current present at the pressure regulating valve that is required for setting the desired rail pressure is measured and compared to an expected setpoint current. The relationship of the two currents is then stored as the adaptation value. In order to achieve a high accuracy of the adaptation, this method has to be carried out at rail pressures that are as high as possible, which are, as a rule, only reached at very high load conditions of the internal combustion engine. In addition, in the case of a two-controller approach having a pressure regulating valve, which is usual in CR systems, the APCV function is only able to be carried out if the CR system is in regulating mode, which is usually only active shortly after the start of the internal combustion engine, for the purpose of heating fuel. Since the complete tolerance chain of the CR system and the rail pressure regulation is to be additionally calculated into the monitoring limits of the APCV function for the least favorable case, this leads to great inaccuracy or rather, relatively large tolerances with respect to the monitoring result.

In addition, there comes about a further, relatively large tolerance in the actuation of the pressure regulating valve per se, namely, because of the rail pressure sensor characteristic curve mentioned on which it is based. For, the characteristic curve is set up by setting a corresponding rail pressure at the full flow of fuel through the high pressure pump mentioned, via a certain supply of current to the pressure regulating valve.

### SUMMARY OF THE INVENTION

The present invention is based on the idea of monitoring and checking the functioning of a pressure sensor of a fuel metering system, that is under consideration in this case, by lowering the current supply of a pressure regulating valve, that is first closed, until the pressure regulating valve opens and pressure is dissipated. This is based on the technical effect that, because of the opening of the pressure regulating valve, a measurable and evaluatable current signal is generated. The current signal is particularly generated by the electric current that is induced back by the opening of the pressure regulating valve.

The outflow of fuel conditioned upon what may be a brief opening of the pressure regulating valve has the effect of a (brief) lowering of the hydraulic pressure in the rail, or rather the high-pressure accumulator. With the aid of the exact opening time of the pressure regulating valve, known from the measured current signal, this pressure reduction is able to be compared to pressure values supplied by the pressure sensor, and the functional capability of the pressure sensor is thereby able to be checked and checked for plausibility.

The checking may take place only qualitatively or also quantitatively. Thus, in the case of a quantitative evaluation of the curve over time of the measured current signal, the quality of the checking result or the quality of the plausibility check is able to be improved in that, in addition to evaluating the time of opening of the pressure regulating valve, the duration of the opening of the pressure regulating valve is also evaluated, for instance, by an accurately timed increase in supplying current to the pressure regulating valve, in order to close it again as quickly as possible after its detected opening state, so as to return to the normal operating mode of the pressure regulating valve.

Therefore, the method according to the present invention enables an indirect monitoring or plausibility checking of a pressure sensor under consideration in this case, namely indirectly via the opening behavior of a pressure regulating valve, and is thereby, in particular, independent of the respective operating type of a present pressure regulation.

By contrast to a characteristic curve named at the outset, the method according to the present invention uses the opening behavior of the pressure regulating valve, which may also be characterized by a characteristic curve. For, each pressure regulating valve has manufacturing tolerances conditioned upon production methods and/or variances caused by the operational life. These require the application of certain offsets in the actuating current that has to be applied to a pressure regulating valve, so that it closes reliably. In order to be able to maintain a closing pressure of 2000 bar, for instance, the pressure regulating valve requires a pressure of 2000 bar+x bar in closing offset, the latter being recalculated to a current. Depending on the manufacturer and the type of the pressure regulating valve, this closing offset is lower than the characteristic curve already named. In this context, the opening tolerance is considerably smaller than the characteristic curve tolerance in the active control and/or regulating operation of the pressure regulating valve.

Using the method according to the present invention, one is additionally able to ascertain the opening time of a previously closed pressure regulating valve in the whole working range of the pressure regulating valve and the whole pressure range of the fuel metering system, i.e. in a CR system of minimum rail pressure to maximum rail pressure, a direct dependence coming about between the pressure currently present at the pressure valve and the closing pressure of the pressure regulating valve currently present. Thereby the functional capability of a pressure sensor under consideration in this case, i.e. a rail pressure sensor in the case of a CR system, may be checked for plausibility at a higher accuracy than is possible using the known methods, such as the APCV function named at the outset.

The present invention may be used in a pressure-operated fuel metering system of a motor vehicle, especially in a high-pressure operated CR injection system. It should be understood, though, that the method may also be used outside the usual motor vehicle technology, for instance, in special commercial vehicles, in watercraft, or in chemical industrial processing engineering, with the same advantages described herein.

Additional advantages and developments of the present invention result from the specification and the appended figures.

It will be appreciated that the features mentioned above and the features yet to be described below may be used not only in the combination given in each case but also in other combinations or individually, without departing from the scope of the present invention.

### BRIEF DESCRIPTION OF THE DRAWINGS

FIG. 1 shows a schematic block diagram of a fuel injection system under consideration in this case, according to the related art, for which the method according to the present invention is applicable.

FIGS. 2a and 2b show, in the case of a pressure regulating valve under condideration in this case, measured electrical current curves to illustrate the current induced back in response to an opening process of the pressure regulating valve.

FIG. 3 shows an exemplary embodiment of the method according to the present invention, with the aid of a flow chart.

FIG. 4 shows schematically the curve of a pulse-width modulated control voltage for operating a pressure regulating valve under consideration in this case, to illustrate the current measuring method used according to the present invention.

### DETAILED DESCRIPTION

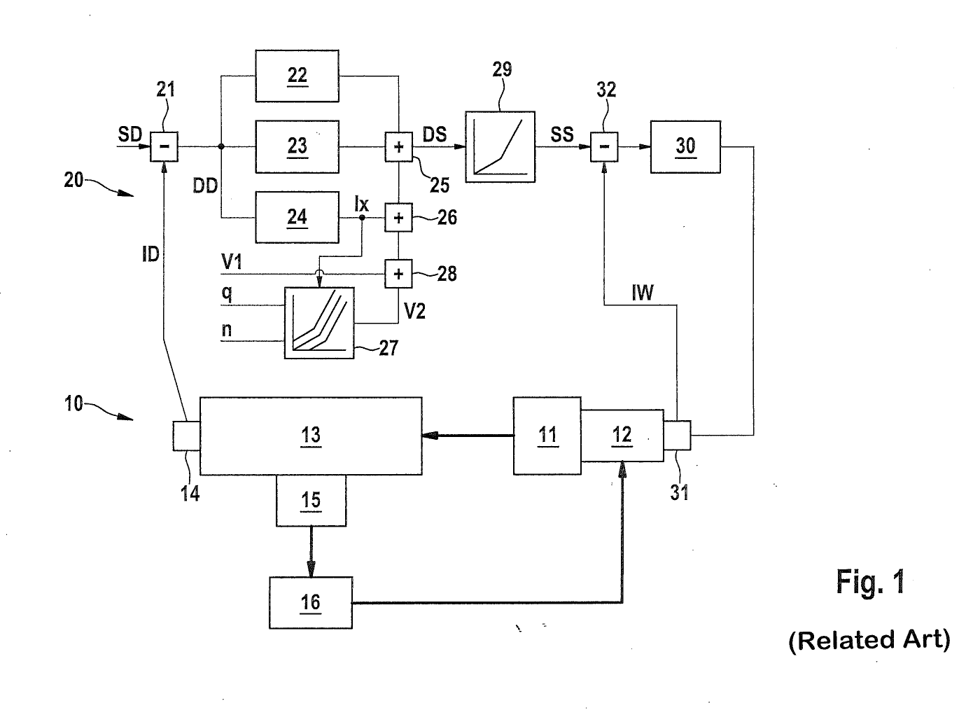

FIG. 1 shows a fuel injection system 10 of an internal combustion engine, which may be a high pressure fuel injection system of a Diesel internal combustion engine for a motor vehicle. Fuel injection system 10 has a pump 11, particularly a high pressure pump, to which the fuel is supplied via a metering unit 12. On its output side, pump 11 is connected to a rail 13, in which the fuel is stored under a pressure. In a manner not shown, rail 13 is connected to fuel injectors, via which the fuel is injected into combustion chambers of the internal combustion engine. A pressure regulating valve 15 is connected to rail 13 or rather, situated on it, using which, the outflow of fuel from the rail (i.e. high pressure rail) 13, that is under high pressure, into an only schematically indicated low pressure accumulator 16 takes place in a regulated manner, whereby the pressure in rail 13 is able to be regulated. To regulate the pressure in rail 13, i.e. to ascertain an actual value of the pressure, a pressure sensor 14 is assigned to rail 13, particularly a rail pressure sensor (RPS), using which, the pressure in rail 13 is measured.

The entire fuel injection system 10 is controlled and/or regulated by a control unit not shown in greater detail. For this, the control unit has a computer having an electrical storage medium, in particular, a flash memory. A computer program is stored on the memory medium, which is able to be run on the computer. This computer program is suitable for influencing fuel injection system 10 and thereby carrying out the desired control and/or regulation.

In addition to fuel injection system 10, in FIG. 1 a method 20, for operating this fuel injection system 10, is also shown in the form of a block diagram. This method is performed by the control unit. If necessary, parts of method 20 may also be implemented with the aid of analogous electronic components.

Pressure sensor 14 generates a signal corresponding to the actual pressure ID in rail 13, and is sent to a comparator 21. There, the actual pressure ID is compared to a setpoint pressure SD. The differential pressure DD is passed on to three controllers, namely to a P controller 22 (proportional controller), a D controller 23 (differential controller) and an I controller 24 (integral controller). The outputs of these three controllers are added by an adder 25 to form a control value DS for a desired fuel flow. This desired fuel flow is then supposed to be supplied by metering unit 12 to pump 11, and thus to rail 13.

Furthermore, a first pilot signal V1 is provided. which is added via a first adder 26 to control value DS, as well as a pilot control characteristic map 27, which on the output side supplies a second pilot control signal V2, which, via a second adder 28, is added to control value DS for the fuel flow. As input signal, current injection quantity q and current rotational speed n are supplied to pilot control characteristic map 27.

Control value DS for the desired fuel flow is supplied to a characteristic curve 29, which represents metering unit 12. With the aid of this characteristic curve 29, from a control value DS, that control value SS for a current is ascertained, with which metering unit 12 has to be actuated in order to produce the desired fuel flow. This control value SS represents a setpoint value for a post-connected current regulator 30. Metering unit 12 then has applied to it the current corresponding to control value SS by current regulator 30. The current actually flowing via metering unit 12 is measured by a sensor 31, and supplied as actual value IW to a comparator 32. There, actual value IW is deducted from control value SS. The difference is then applied to current regulator 30.

To check the functioning capability of a pressure sensor 14 shown in FIG. 1, the method of checking the plausibility is used that is described below. The method is based on an ascertainment, that is as accurate as possible, of the opening time of a pressure regulating valve 15 shown in FIG. 1. In the method, use is particularly made of the idea that, when the pressure regulating valve is opened, an electric (induction) current is briefly induced or induced back in the driver coil or driver winding of the pressure regulating valve. This brief current change is detected, and from it one may conclude that there is an opening pressure regulating valve, the opening taking place in that the rail pressure present at the pressure regulating valve is greater than the closing pressure set by the pressure regulating valve.

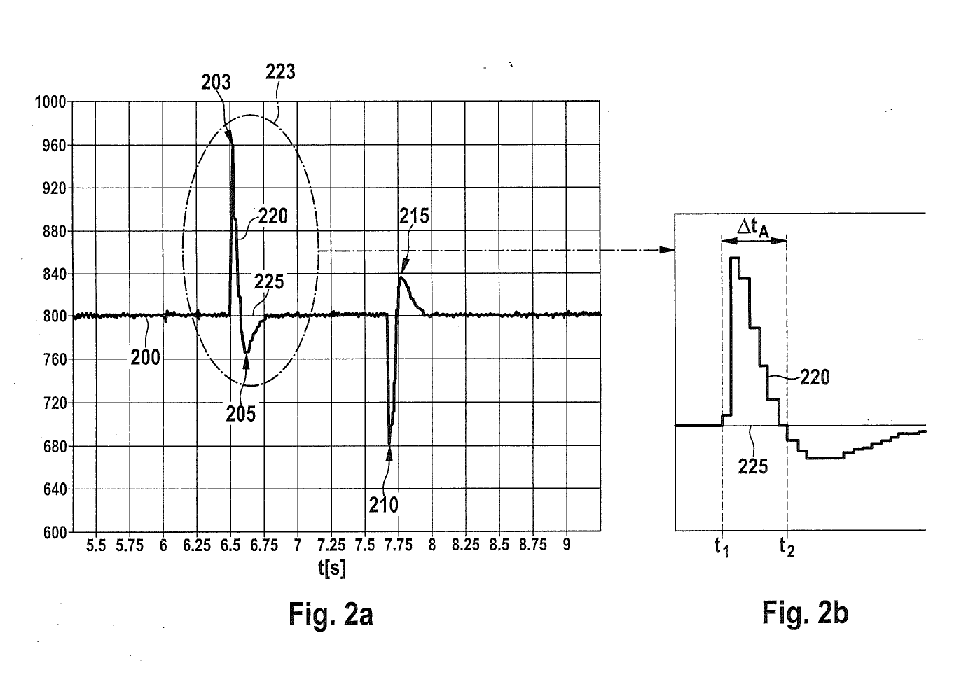

The current mentioned, induced back in response to the opening process of the pressure regulating valve, is illustrated with the aid of the measuring curve shown in FIGS. 2a and 2b.

FIG. 2a shows an electric current curve I_{DRV} in units of milliAmpere (mA) as actual value 200 of the current as well as a specified setpoint value 225 of the current. In time window 223, that is emphasized by a dot-dashed line, there is a brief current increase 220 of actual value 200, which is used in the method described herein as the basis for determining the exact opening time of the pressure regulating valve.

In FIG. 2a the current curves are shown that come about both during opening and during sequent closing of pressure regulating valve 15. The peak-shaped rise 203 shown comes about due to the opening of pressure regulating valve 15, whereas the slighter undershoot 205 results from the regulating intervention caused by the current peak. When pressure regulating valve 15 is closed, because of the corresponding back induction, there first comes about a peak-shaped undershoot 210 and a subsequent, slighter overshoot 215, also caused by an intervention of the current regulator mentioned.

FIG. 2b shows a cutout enlargement of area 223, shown in FIG. 2a, of current increase 220 as well as of setpoint value 225. Based on the relatively high measuring resolution, from this measuring curve one is able to ascertain very accurately time t₁ of opening pressure regulating valve 15, which, in the present exemplary embodiment is on the present time scale t(s) at approximately t₁=6.5 s. The time duration Δt_{A}=t₂ −t₁ of brief current increase 220 here amounts to only about 0.05 s. These time data show that the detection, according to the present invention, of the opening of pressure regulating valve 15 via an electrical path (back induced current) is quicker than the detection via a hydraulic path (e.g. via values supplied by the rail pressure sensor). For this reason, using the electrical variables, one detects more rapidly that pressure regulating valve 15 is opening.

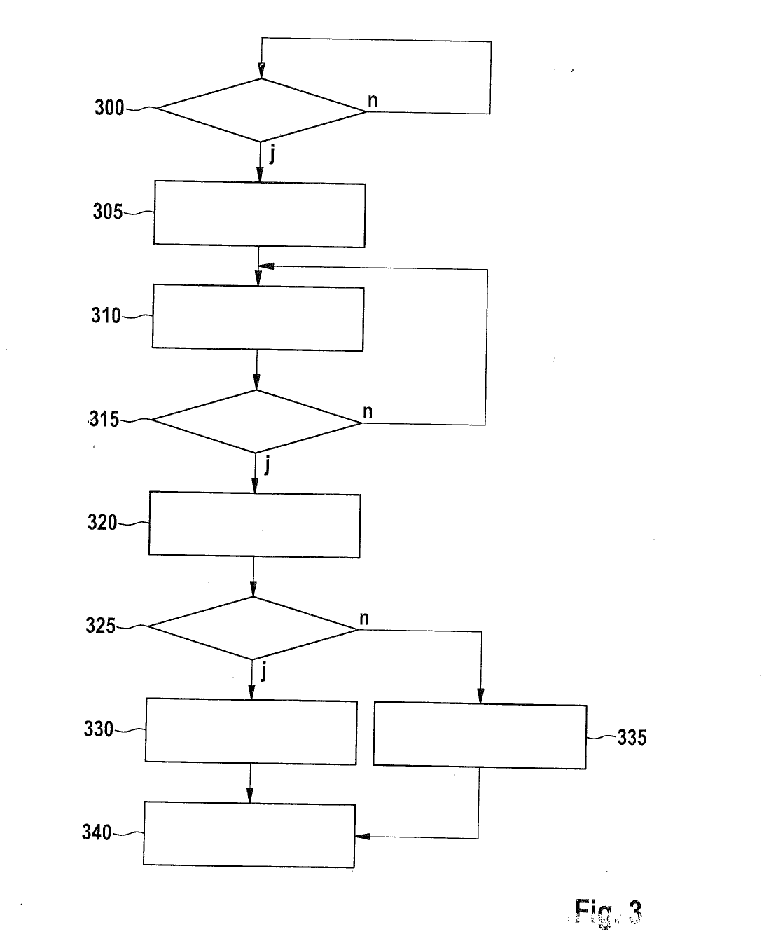

The indirect checking or monitoring of the functioning of pressure sensor 14 mentioned takes place with the aid of the exemplary embodiment of a method sequence (or routine) shown in FIG. 3, which checks the plausibility of the functional capability of pressure sensor 14 based on the current induced back that is measured at pressure regulating valve 15. With the aid the exact opening time of pressure regulating valve 15 thus ascertained indirectly, the pressure drop in the rail, caused thereby, is checked for plausibility using actual values delivered by pressure sensor 14. The cause of the pressure drop is that, in a CR system shown in FIG. 1, in response to the opening of pressure regulating valve 15, fuel flows off into low-pressure system 16, whereby the rail pressure goes down. The plausibility check may take place exclusively with reference to time, that is, by a comparison of the ascertained time of the opening of the pressure regulating valve with the pressure values supplied by the pressure sensor, which should demonstrate a corresponding pressure change at the time named.

In the exemplary embodiment shown in FIG. 3, of a routine according to the present invention, it is first checked 300 whether pressure regulating valve 15 is closed. If this is not the case, a return to the beginning of the routine takes place in the form of a loop. If it is determined that pressure regulating valve 15 is closed, in the following step 305 a first actual pressure value ID#1, supplied by pressure sensor 14, is recorded and stored temporarily.

In the following step 310, the supplying of current to pressure regulating valve 15 is lowered by an empirically specified differential value. Thereafter, it is checked 315, whether the current measurement mentioned (described in detail below) has recorded a (peak) current that was induced back. If this is not the case, the method returns to step 310, and the supply of current to the pressure regulating valve is correspondingly further lowered or reduced at the increment mentioned. If it turns out at test step 315, after such a further lowering of the supply of current, that a peak current induced back was measured, in subsequent step 320, a second actual pressure value ID#2, supplied, in turn, by pressure sensor 14, is recorded and also stored temporarily, if necessary.

The two values ID#1 and ID#2 are now compared in test step 325. If the test yields that the value of ID#2, for instance, within an empirically specifiable threshold value, is greater than the value of ID#1, which means that the condition in step 325 is satisfied, the method goes forward to step 330, and it is signaled to a diagnostic unit (e.g. OBD unit) or the like that pressure sensor 14 is fully functionally capable.

Otherwise the method goes to step 325, in which a malfunction of pressure sensor 14 is signaled.

Finally, in step 340 the supply of current to pressure regulating valve 15 is raised again to the original current value (i.e. before the beginning of the routine), in order to close the pressure regulating valve again for normal operation.

Alternatively or in addition to the plausibility check described, it may be provided that the peak current induced back, as was described above, is evaluated in greater detail, whereby the quality of the plausibility check is able to be improved.

The method described may advantageously be used or carried out in all possible operating states of a fuel metering system on which they are based (e.g. CR systems), in which the pressure regulating valve is closed, and consequently, over the entire pressure range available in the rail, since at each pressure, the operating current (or the control current) is able to be lowered for the pressure regulating valve, in the manner described, until an opening signal of the pressure regulating valve is measured and recorded. Thereafter, the operating current of the pressure regulating valve may quickly be raised again, whereby the rapid current drop, based on the quick detection of the opening, has no significant influence or negative effect on the currently present rail pressure or the injection behavior of the CR system.

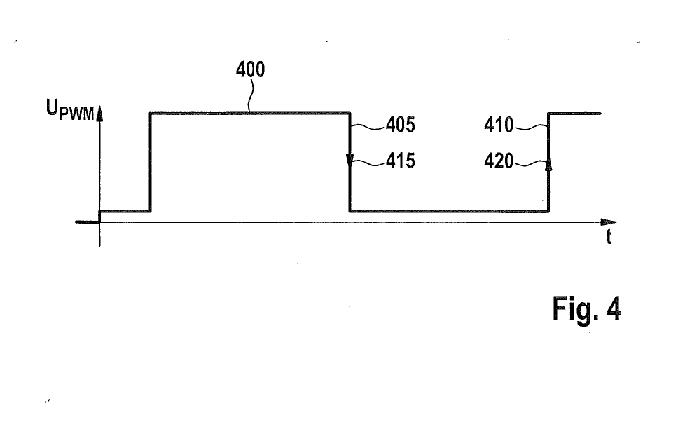

The brief current change that is significant for the opening of the pressure regulating valve, which may be a rise in current, is able to be ascertained by the method described below with the aid of FIG. 4, for current measurement on an inductive load. FIG. 4 shows schematically a pulse width-modulated (PWM) voltage signal 400 as a function of time t. In the exemplary embodiment, the two signal edges 405, 410 of the PWM signal are the basis for the current measurement, a first current measurement 415 taking place at dropping edge 405 and a second current measurement 420 taking place at rising edge 410.

The current measurement is particularly carried out synchronously at the two edges 405, 410 of PWM signal 400, and from the current values obtained, which correspond to a minimum current and a maximum current, an average value is formed. The average value that comes about is assumed to be the current value induced back.

It should be noted that the exemplary embodiment, shown in FIG. 4, uses a control voltage signal, that is the basis in the actuation of the pressure regulating valve, which effects the control current, described, through the coil of the pressure regulating valve. This voltage signal is present, for example, in a control unit of the CR system, and may therefore be read out appropriately, in order to evaluate the currents coming about at the voltage edges 405, 410 described.

Using the method described, a plausibility check of a pressure sensor of a fuel metering system, that is under discussion here, is able to be carried out with greater accuracy, and in addition, an operating range being accessible for the plausibility check which is not covered by the related art, such as the APCV function mentioned.

The method described may be implemented either in the form of a control program in an existing control unit for controlling an internal combustion engine, or in the form of a corresponding control unit.

What is claimed is:

1. A method for monitoring a pressure sensor of a fuel metering system of an internal combustion engine, the fuel metering system having a metering unit controlling the inflow of fuel into a rail, the method comprising:
metering fuel from the rail into combustion chambers of the internal combustion engine;
regulating, using a pressure regulating valve which is connected to the rail, an outflow of fuel from the rail into a low pressure accumulator; and
measuring the pressure in the rail using the pressure sensor;
lowering, for the closed pressure regulating valve, the supply of current to the pressure regulating valve until the pressure regulating valve opens and effects a pressure drop in the rail;
comparing at least one pressure value recorded by the pressure sensor to the pressure drop in the rail; and
drawing, from the result of the comparison, a conclusion based on the functional capability of the pressure sensor.

2. The method of claim 1, wherein the opening of the pressure regulating valve is ascertained by an electric current that is induced back.

3. The method of claim 1, wherein the pressure drop in the rail is caused by the opening of the pressure regulating valve and the fuel flowing out because of that into the low-pressure accumulator.

4. The method of claim 1, wherein the at least one pressure value supplied by the pressure sensor is compared over time with the pressure change in the rail, and from the result of the comparison over time, a conclusion is drawn on the functional capability of the pressure sensor.

5. The method of claim 1, wherein the comparison of the at least one pressure value supplied by the pressure sensor to the pressure change in the rail is based on the duration in time of the opening of the pressure regulating valve.

6. The method of claim 1, wherein after it has been determined that the pressure regulating valve is closed, performing the following:
recording at least one first pressure value supplied by the pressure sensor;
lowering the current supplied to the pressure regulating valve by a specified value;
carrying out a current measurement at the pressure regulating valve;
checking whether a current change is determined at the pressure regulating valve;
recording, for a determined current change, at least one second pressure value supplied by the pressure sensor;
comparing the at least two pressure values recorded; and
drawing a conclusion on the functional capability of the pressure sensor as a function of the result of the comparison.

7. The method of claim 6, wherein the application of current to the pressure regulating valve is raised again at the end of the tasks to close the pressure regulating valve again.

8. The method of claim 6, wherein at least one of the checking of whether a current change has taken place, and the comparing of the at least two recorded pressure values, occurs based on specified threshold values.

9. A computer readable medium having a computer program, which is executable by a processor, comprising:
a program code arrangement having program code for monitoring a pressure sensor of a fuel metering system of an internal combustion engine, the fuel metering system having a metering unit controlling the inflow of fuel into a rail, by performing the following:
metering fuel from the rail into combustion chambers of the internal combustion engine;
regulating, using a pressure regulating valve which is connected to the rail, an outflow of fuel from the rail into a low pressure accumulator; and
measuring the pressure in the rail using the pressure sensor;
lowering, for the closed pressure regulating valve, the supply of current to the pressure regulating valve until the pressure regulating valve opens and effects a pressure drop in the rail;
comparing at least one pressure value recorded by the pressure sensor to the pressure drop in the rail; and
drawing, from the result of the comparison, a conclusion based on the functional capability of the pressure sensor.

10. The computer readable medium of claim 9, wherein the opening of the pressure regulating valve is ascertained by an electric current that is induced back.
